(19) United States
(12) Patent Application Publication
(10) Pub. No.: US 2002/0152113 A1
(43) Pub. Date: Oct. 17, 2002

(54) Software system for quantitative measurement of accountability of social services

(76) Inventor: Stephen Butz, Baltimore, MD (US)

Correspondence Address: Law Offices of Royal W. Craig, Suite 153, 10 North Calvert Street, Baltimore, MD, 21202, US

(21) Appl. No.: 09/976,481

(22) Filed: Oct. 12, 2001

Related U.S. Application Data
(60) Provisional application No. 60/239,770, filed on Oct. 12, 2000.

(51) Int. Cl. G06F 17/60

(52) U.S. Cl. 705/11

(57) ABSTRACT

A system for social service case management tat facilitates storage and querying of social services data in a knowledgebase in order to provide quantitative accountability for social services via a navigable user interface. The method includes the tracking and assessment of social services based on a defined list of client barriers to success and an indication of the severity of each barrier, and then objectively tracking progress of the social worker based on the reduction of severity and/or elimination of those barriers. The method is implemented in software form using a structured relational database whereby storage tables are inter-related by one or more shared fields. All of the foregoing method steps are administered to and by the social worker using a navigable user interface. The graphical user interface includes a plurality of single-click buttons each for initiating a pre-determined SQL query for allowing a user to generate a report for maintaining quantitative accountability for social services.

### BACKGROUND OF THE INVENTION

The present invention derives priority from U.S. Provisional Patent Application No. 60/239,770 entitled “SOFTWARE SYSTEM FOR QUANTITATIVE MEASUREMENT AND ACCOUNTABILITY OF SOCIAL SERVICES”, filed: Oct. 12, 2000.

### BACKGROUND OF THE INVENTION

1. Field of the Invention

The present invention relates to a social service case management and, more particularly, to a method for the tracking and assessment of social services data in a knowledge base that provides quantitative accountability for social services based on reduction of barriers. The method is implemented in software form with a navigable user interface.

2. Description of the Background

State legislatures are pressuring agencies to become more efficient in the delivery of social services. Unfortunately, while many agencies excel at providing quality services, there is currently very little that an agency can do to quantitatively assess the effectiveness of its counselors. Surveys have been completed which show that counselors do very little evaluation of their work with clients, and as many as 40% of counselors report doing no evaluation. When evaluation is done, it tends to be with the client in the session by asking the client if the session was helpful. No quantitative assessment is made of the impact of counseling on the client's situation. Consequently, there is currently no reliable way for an agency to assess the effectiveness of its counselors, or just as important, for counselors to quantify their performance to their agencies. Previously, managers and consultants did not place a high priority on evaluating counseling effects. However, funding pressures are emphasizing the need for efficiency, and that is forcing the need for assessment. Indeed, counselors are beginning to see that without data to attest to their successes, their jobs are vulnerable. Survey results indicate that up to 42% of counselors do not know to what extent their supervisors' expectations were being met. This presents a high risk that program administrators may assume that counseling is not necessary. Counselors need to become more active at marketing what they do and the results they achieve (i.e., the nature of service, nature of program, results of evaluation). They know this and yet can do nothing about it. Unfortunately, there is no generally-accepted method of collecting and evaluating counseling data. Few models exist for evaluating the actual effects of counseling, and Counselors and managers need a functional assessment approach. The present inventor has found that it is possible to map barriers to client progress. For example, in career counseling, clients have specific “barriers” to productivity including: a lack of belief in self; low motivation to change; belief that potential for success is low; finances (especially for clients in colleges and CECs); family responsibilities (especially for clients in college or working mothers); and unemployment. It is possible to map the major career-related problems within the context of the client's life. Given the barriers to success, the Counselors can be more prepared to work with clients to help them overcome the barriers they face. This improves the Counselor's effectiveness and efficiency. More importantly for the present purposes, it provides a foothold for objective assessment: a model for evaluating the actual effects of counseling based on reducing or eliminating barriers. It would therefore be greatly advantageous to provide a method and means for assessing social service case workers based on an objective prioritized mapping of barriers to client progress. It would also be advantageous to implement this new form of evaluation model as software in a distributed computing environment tom increase visibility and use across at all levels in the organization, with supervisors sharing their evaluations with workers and vice versa. This would help to ensure an integrated approach to service delivery.

Currently, there are many existing systems for electronic storage and retrieval of information that are specially adapted in certain respects to various industries. For example, Key-word search engines like Pubmed® allow users to find articles based on Boolean combinations of MESH headings, author, or keyword string searches. These are currently not well-adapted for social service case management because the data is so highly subjective and is scattered across heterogeneous databases that are difficult to link and query. Consequently, there is a need to develop a better system for the storage, retrieval and interpretation of case management information, based on the barrier-mapping model, in order to track and help achieve optimal clinical and financial patient outcomes.

### SUMMARY OF THE INVENTION

Accordingly, it is an object of the present invention to provide a software method for the storage and querying of social service data on the basis of defined social services, general customer demographics, specific customer biographical data, and defined outcomes.

It is another object to provide a system to help manage and coordinate resources for the achievement of optimal clinical and financial patient outcomes, and to facilitate collaborative patient care management across the continuum of available social services.

It is another object to assist in developing, implementing, revising and reporting activities related to any case management program.

It is another object to record information about social-service clients in a database that can be accessed by multiple users at one or more sites.

According to the present invention, these and other objects are accomplished by providing a system for social service case management tat facilitates storage and querying of social services data in a knowledge base that provides quantitative accountability for social services via a navigable user interface. The method includes the tracking and assessment of social services based on a defined list of client barriers to success, and it then objectively tracks progress of the social worker based on the reduction and/or elimination of those barriers. The invention also comprises an implementation of the foregoing method in software form which facilitates the guided compilation of a knowledge base that quantifies the barriers to success, facilitates objective tracking of progress toward the reduction and/or elimination of those barriers, and which generates tangible results by structured querying of the knowledge base and generation of evaluate progress. The collected information is incorporated into a structured relational database whereby storage tables are inter-related by one or more shared fields. All of the foregoing method steps are administered to and by the social worker using a navigable user interface. The graphical user interface includes a plurality of single-click buttons each for initiating a predetermined SQL query for allowing a user to generate a report for maintaining quantitative accountability for social services. The software method is combined with suitable hardware for implementation of the entire system. The hardware may include a conventional computer workstation with standard internal components such as a microprocessor with peripheral chipset mounted on an appropriate motherboard, storage, a monitor, a modem, a standard input device such as a mouse, and an operating system such as Microsoft Windows.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a flow chart illustrating the general method steps according to the present invention.

FIG. 2 is a screen print of an exemplary “Add Participant” screen.

FIG. 3 is a screen print of an exemplary “Participant Demographics” screen.

FIG. 4 is a screen print of an exemplary Progress Element (or Record Efforts) entry/update screen.

FIG. 5 is a screen print of an exemplary Barrier entry/update screen.

FIG. 6 is a screen print of an exemplary “Update Participant Previous Employment” screen.

FIGS. 7A-7C are a tabular listing of the preferred relational links between fields in the above described knowledgebase tables.

FIG. 8 is a screen print of an exemplary Basic Client Information Report profiling a given client.

FIG. 9 is a screen print of an exemplary caseworker report with total client contact information for a given caseworker.

FIG. 10 is a screen print of an exemplary Barrier statistics report.

FIG. 11 is an example “Efforts to Outcomes” report.

FIG. 12 is an example “Barrier Reduction Report” report.

### DETAILED DESCRIPTION OF THE PREFERRED EMBODIMENTS

The present invention is a method for the tracking and assessment of social services based on defining client barriers to success and then objectively tracking progress of the social worker based on the reduction and/or elimination of those barriers. The invention also comprises an implementation of the foregoing method in software form which facilitates the guided compilation of a knowledge base that quantifies the barriers to success, facilitates objective tracking of progress toward the reduction and/or elimination of those barriers, and which generates tangible results by structured querying of the knowledge base and generation of evaluate progress. All of the foregoing steps are administered to the social worker by a navigable user interface.

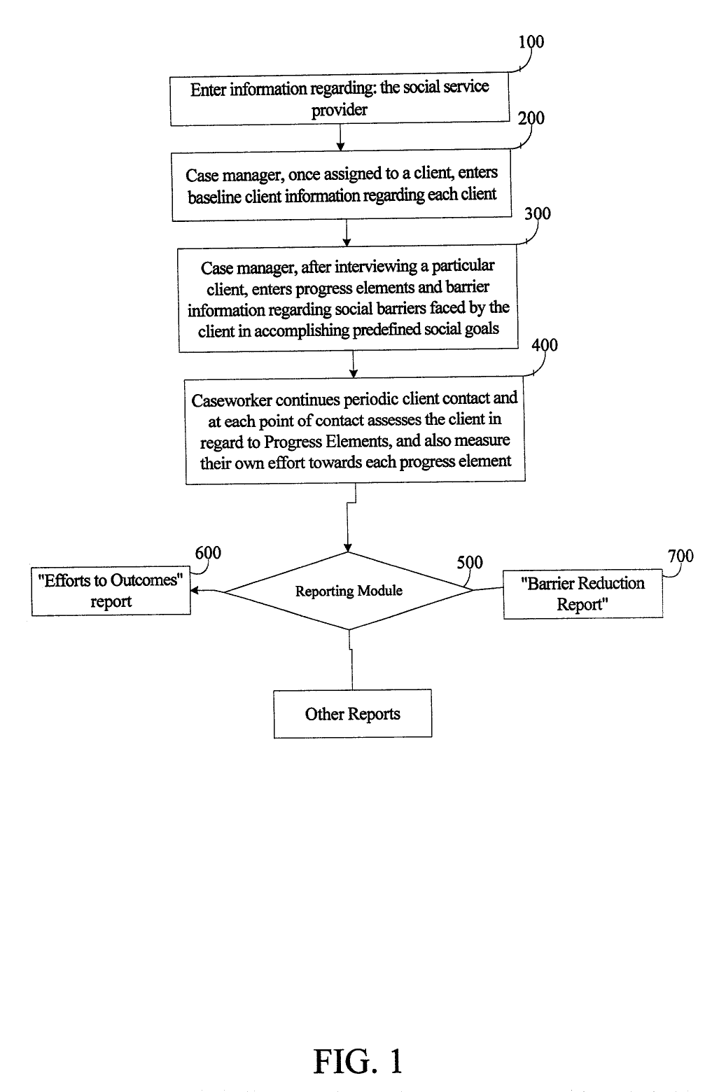

The basic method of the present system in this context are based on a model involving five specific categories of information regarding: 1) the social service provider, 2) the client, 3) client barriers to success inclusive of severity, 4) client outcome, and 4) general demographic data. FIG. 1 is flow chart illustrating the general method steps according to the present invention.

At step 100 the agency and/or individual case managers enter baseline information for each case worker inclusive of basic identifier information such as LastName, FirstName, Case Worker ID#, Employment Date, Position, and other informational fields as desired.

At step 200 the individual case manager, once assigned to a client, enters baseline client information regarding each client inclusive of social security number, name address, ethnicity, gender, etc. Basic client data is used to populate a relational database table as shown below.

“Clients” Table

| Name | Datatype | Null Option | Is PK | Is FK |
|---|---|---|---|---|
| SSN | varchar(11) | NOT NULL | Yes | No |
| FirstName | varchar(20) | NOT NULL | No | No |
| MiddleInitial | char(1) | NULL No | No | |
| LastName | varchar(40) | NOT NULL | No | No |
| OtherPhone | varchar(50) | NULL No | No | |
| PhoneNumber | char(20) | NULL No | No | |
| Address1 | varchar(50) | NULL No | No | |
| Address2 | varchar(50) | NULL No | No | |
| City | varchar(30) | NULL No | No | |
| State | char(2) | NULL No | No | |
| ZipCode | char(5) | NULL No | No | |
| Ethnicity | smallint | NULL No | Yes | |
| Gender | varchar(50) | NULL No | Yes | |
| ClientDOB | smalldatetime | NULL No | No | |
| MaritalStatus | smallint | NULL No | Yes | |
| NonCustodialParent | bit | NULL No | No | |
| TCAExhaustee | bit | NULL No | No | |
| LanguageSpoken | varchar(30) | NULL No | No | |
| SourceOfIncome | smallint | NULL No | Yes | |
| I9SocialSecurityCard | bit | NULL No | No | |
| I9BirthCertificate | bit | NULL No | No | |
| I9DriverLicense | bit | NULL No | No | |
| I9LicenseNumber | varchar(30) | NULL No | No | |
| I9LicenseType | smallint | NULL No | Yes | |
| EducationGoal | varchar(50) | NULL No | No | |
| EducationHighestGrade | smallint | NULL No | No | |
| Attended | | | | |
| EducationLastYearInSchool | datetime | NULL No | No | |
| GED | bit | NULL No | No | |
| EducationProjectedGED | datetime | NULL No | No | |
| Date | | | | |
| ProfessionalLicenses | varchar(50) | NULL No | No | |
| MilitaryServiceEntry | datetime | NULL No | No | |
| MilitaryServiceDis- | bit | NULL No | No | |
| charge | | | | |
| MilitaryServiceDischarge | smallint | NULL No | Yes | |
| Type | | | | |
| MilitaryBranch | smallint | NULL No | Yes | |
| MilitaryDischargeDate | datetime | NULL No | No | |
| CriminalFelonyConviction | bit | NULL No | No | |
| CriminalMisdemeanor | bit | NULL No | No | |
| Conviction | | | | |
| CriminalCivilCase | bit | NULL No | No | |
| CriminalDateOfLastOffense | smalldatetime | NULL No | No | |
| CriminalDispositionType | smallint | NULL No | Yes | |
| CriminalProbation | bit | NULL No | No | |
| CriminalBackgroundCheck | bit | NULL No | No | |
| EmploymentFOF | smallint | NULL No | Yes | |
| EmploymentShortTerm | varchar(100) | NULL No | No | |
| Goal | | | | |
| EmploymentTraining | text | NULL No | No | |
| Needed | | | | |
| EmploymentTraining | text | NULL No | No | |
| Completed | | | | |
| ReliableName | varchar(50) | NULL No | No | |
| ReliableNumber | varchar(50) | NULL No | No | |
| ReliableCity | varchar(50) | NULL No | No | |
| ReliableState | varchar(2) | NULL No | No | |
| ReliableZip | varchar(5) | NULL No | No | |
| ReliableRelationship | varchar(30) | NULL No | No | |
| SocialWorkName | varchar(50) | NULL No | No | |
| SocialWorkNumber | varchar(30) | NULL No | No | |
| SocialWorkLocation | varchar(30) | NULL No | No | |
| PhoneNumber2 | char(20) | NULL No | No | |
| EmployeeIDOriginal | smallint | NULL No | No | |

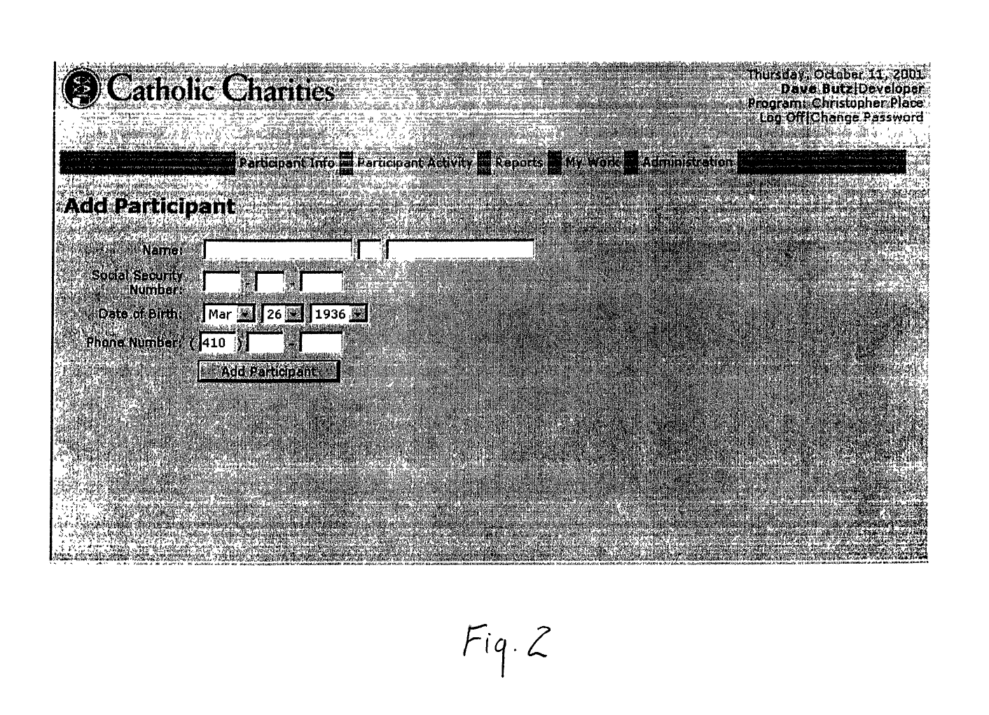

FIG. 2 is a screen print of an exemplary “Add Participant” screen by which the caseworker is guided to add a new client and to enter basic details such as Name, SSN, PhoneNumber, and Date of Birth into the above table.

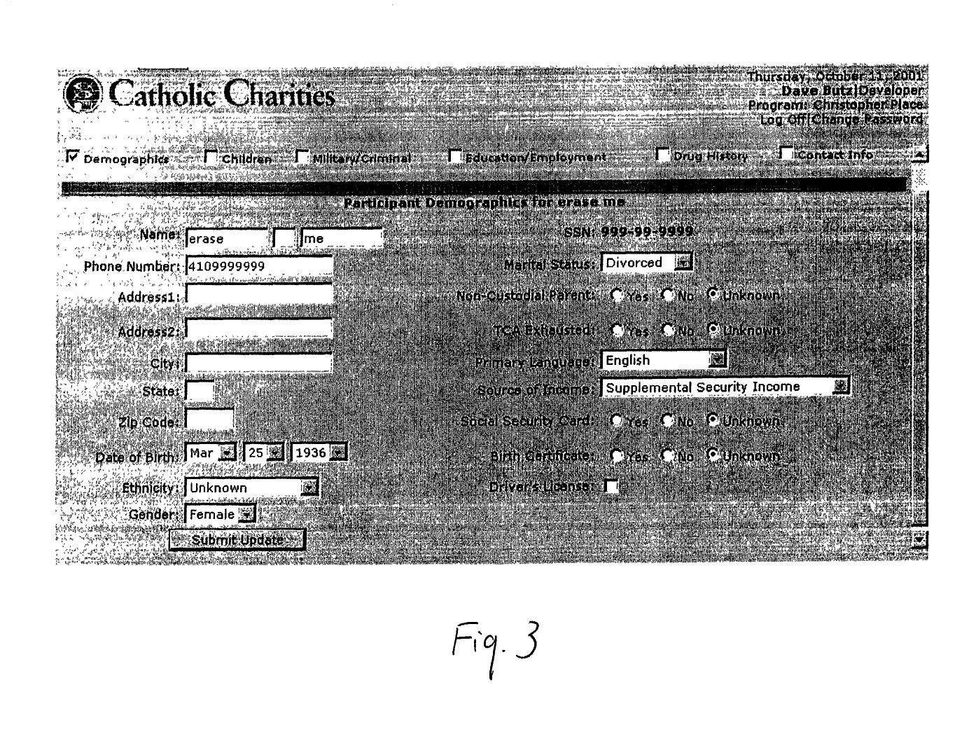

FIG. 3 is a screen print of an exemplary “Participant Demographics” screen by which the caseworker is guided to add client particulars. Previously entered data appears in the screen and additional data as shown can be entered into the relevant fields per the above table.

In addition to basic client data, subordinate client data is entered by a succession of like screens and is used to populate a series of related tables. Preferably, in the context of employment placement, the subordinate data will include relevant information on the client's children, drug addictions, criminal dispositions, employment history, license types, military history, test scores, marital status, medical benefits availability, prior placements (including rejections), program outcomes, referral sources, and other data as desired. The following are an exemplary set of table definitions for storing this subordinate data.

| | | | | |
|---|---|---|---|---|
| Name | Datatype | Null Option | Is PK | Is FK |

“ChildRelationshipType” Table

| | | | | |
|---|---|---|---|---|
| ChildRelationshipID | smallint | IDENTITY | Yes | No |
| ChildRelationship | varchar(50) | NULL | No | No |

“Choice” Table

| | | | | |
|---|---|---|---|---|
| Choice | varchar(10) | NOT NULL | No | No |
| ChoiceID | smallint | NOT NULL | No | No |

“ClientAddictions” Table

| | | | | |
|---|---|---|---|---|
| SSN | varchar(11) | NOT NULL | Yes | Yes |
| AddictionID | smallint | IDENTITY | Yes | Yes |
| AddictionHistory | smallint | NULL | No | No |
| LenghtOfDrugUser | varchar(30) | NULL | No | No |
| DateOfLastUser | smalldatetime | NULL | No | No |
| DrugTested | bit | NULL | No | No |
| DateOfDrugTest | smalldatetime | NULL | No | No |
| DrugTestResult | varchar(50) | NULL | No | No |
| RecoveryInfo | varchar(50) | NULL | No | No |

“ClientChildren” Table

| | | | | |
|---|---|---|---|---|
| SSN | varchar(11) | NOT NULL | Yes | Yes |
| ChildFirstName | varchar(20) | NOT NULL | Yes | No |
| ChildLastName | varchar(40) | NOT NULL | Yes | No |
| ChildDOB | smalldatetime | NULL | No | No |
| ChildRelationship | smallint | NULL | No | Yes |

“ClientCriminalDisposition” Table

| | | | | |
|---|---|---|---|---|
| CriminalDisposition | varchar(30) | NOT NULL | No | No |
| CriminalDispositionID | smallint | IDENTITY | Yes | No |

“ClientEmployment” Table

| | | | | |
|---|---|---|---|---|
| PlacementID | smallint | NOT NULL | Yes | No |
| DateEntered | datetime | NOT NULL | Yes | No |
| EmployerID | smallint | NOT NULL | No | Yes |
| TerminationDate | smalldatetime | NULL | No | No |
| JobTitle | varchar(50) | NULL | No | No |
| Hourly Wage | money | NULL | No | No |
| HoursPerWeek | smallint | NULL | No | No |
| MedicalBenefits- | smallint | NULL | No | Yes |
| AvailabilityID | | | | |
| FringeBenefitsAvailable | bit | NULL | No | No |
| CoveredByUnemployment- | bit | NULL | No | No |
| Insurance | | | | |
| EmploymentStatus | smallint | NOT NULL | Yes | Yes |
| DOTCode | varchar(30) | NULL | No | No |
| CompletedProbation | bit | NULL | No | No |
| StartDate | datetime | NULL | No | No |

“ClientEmploymentFOFTypes” Table

| | | | | |
|---|---|---|---|---|
| EmploymentFOF | varchar(50) | NOT NULL | No | No |
| EmploymentFOFID | smallint | IDENTITY | Yes | No |

“ClientI9LicenseTypes” Table

| | | | | |
|---|---|---|---|---|
| I9LicenseType | varchar(30) | NOT NULL | No | No |
| I9LicenseTypeID | smallint | IDENTITY | Yes | No |

“ClientMilitaryDischargeTypes” Table

| | | | | |
|---|---|---|---|---|
| MilDischargeTypeID | smallint | NOT NULL | Yes | No |
| MilDischargeType | varchar(30) | NULL | No | No |

“ClientPreviousEmployment” Table

| | | | | |
|---|---|---|---|---|
| SSN | varchar(11) | NOT NULL | Yes | No |
| Company | varchar(50) | NULL | No | No |
| JobTitle | varchar(30) | NULL | No | No |
| StartDate | datetime | NOT NULL | Yes | No |
| EndDate | datetime | NULL | No | No |
| HourlyRate | money | NULL | No | No |
| HoursPerWeek | smallint | NULL | No | No |
| ReasonForLeaving | varchar(50) | NULL | No | No |

“ClientSourceOflncome” Table

| | | | | |
|---|---|---|---|---|
| SourceOfincome | varchar(50) | NOT NULL | No | No |
| SourceOfincomeID | smallint | IDENTITY | Yes | No |

“ClientTestScores” Table

| | | | | |
|---|---|---|---|---|
| SSN | varchar(11) | NOT NULL | Yes | Yes |
| TestDate | smalldatetime | NOT NULL | Yes | No |
| DateEntered | datetime | NOT NULL | No | No |
| Score | numeric(5,2) | NULL | No | No |
| EmployeeID | smallint | NULL | No | No |
| TestType | varchar(50) | NOT NULL | Yes | Yes |

“Employers” Table

| | | | | |
|---|---|---|---|---|
| EmployerID | smallint | IDENTITY | Yes | No |
| Name | varchar(50) | NOT NULL | No | No |
| Address1 | varchar(50) | NULL | No | No |
| Address2 | varchar(50) | NULL | No | No |
| City | varchar(30) | NULL | No | No |
| State | char(2) | NULL | No | No |
| ZipCode | char(5) | NULL | No | No |
| ContactName | varchar(30) | NULL | No | No |
| ContactNumber | varchar(30) | NULL | No | No |
| Commitment | varchar(30) | NULL | No | No |
| RateOfPay | varchar(30) | NULL | No | No |
| Benefits | varchar(30) | NULL | No | No |
| EmployerMatch | varchar(30) | NULL | No | No |

“EmploymentStatuses” Table

| | | | | |
|---|---|---|---|---|
| EmploymentStatus | varchar(50) | NOT NULL | No | No |
| EmploymentStatusID | smallint | IDENTITY | Yes | No |

“Ethnicities” Table

| | | | | |
|---|---|---|---|---|
| Ethnicity | varchar(20) | NOT NULL | No | No |
| EthnicityID | smallint | IDENTITY | Yes | No |

“Genders” Table

| | | | | |
|---|---|---|---|---|
| Gender | varchar(50) | NOT NULL | Yes | No |

“MaritalStatuses” Table

| | | | | |
|---|---|---|---|---|
| MaritalStatus | varchar(50) | NOT NULL | No | No |
| MaritalStatusID | smallint | IDENTITY | Yes | No |

“MedicalBenefitsAvailability” Table

| | | | | |
|---|---|---|---|---|
| MedicalBenefits- | smallint | IDENTITY | Yes | No |
| AvailabilityID | | | | |
| MedicalBenefitsAvailability | varchar(50) | NOT NULL | No | No |

“Messages” Table

| | | | | |
|---|---|---|---|---|
| MessageID | smallint | IDENTITY | Yes | No |
| MessageType | smallint | NULL | No | No |
| MessageText | text | NULL | No | No |
| MessageDateStart | datetime | NULL | No | No |
| MessageDateEnd | datetime | NULL | No | No |
| EmployeeID | smallint | NULL | No | Yes |

“MilitaryBranch” Table

| | | | | |
|---|---|---|---|---|
| MilitaryBranchID | smallint | IDENTITY | Yes | No |
| MilitaryBranch | varchar(30) | NOT NULL | No | No |

“PlacementRejectionReasons” Table

| | | | | |
|---|---|---|---|---|
| PlacementRejectionReason | varchar(30) | NOT NULL | No | No |
| RejectionReasonID | smallint | IDENTITY | Yes | No |
| Notes | text | NULL | No | No |

“Placements” Table

| | | | | |
|---|---|---|---|---|
| PlacementID | smallint | IDENTITY | Yes | No |
| SSN | varchar(11) | NOT NULL | Yes | No |
| PlacementDate | smalldatetime | NOT NULL | Yes | No |
| ScheduledStartDate | smalldatetime | NOT NULL | No | No |
| EmployeeID | smallint | NOT NULL | No | No |
| Notes | text | NULL | No | No |
| ProgramID | smallint | NULL | No | Yes |
| PlacementType | smallint | NULL | No | Yes |
| ReferralSource | smallint | NULL | No | Yes |
| RejectionReason | smallint | NULL | No | Yes |
| OpenToPlace | bit | NULL | No | No |
| OpenToPlaceDate | datetime | NULL | No | No |

“PlacementTypes” Table

| | | | | |
|---|---|---|---|---|
| PlacementTypeID | smallint | IDENTITY | Yes | No |
| PlacementType | varchar(30) | NOT NULL | No | No |

“PreviousEmploymentReasonForLeaving” Table

| | | | | |
|---|---|---|---|---|
| ReasonForLeaving | varchar(50) | NOT NULL | No | No |
| ReasonForLeavingID | smallint | IDENTITY | Yes | No |

“ProgramOutcomes” Table

| | | | | |
|---|---|---|---|---|
| PlacementID | smallint | NOT NULL | Yes | No |
| DateEntered | datetime | NOT NULL | No | No |
| EmpID | smallint | NOT NULL | No | No |
| ProgramHours | decimal(10,2) | NOT NULL | No | No |
| Date Worked | datetime | NOT NULL | Yes | No |
| Notes | text | NULL | No | No |
| WorkActivityType | smallint | NOT NULL | Yes | Yes |

“Programs” Table

| | | | | |
|---|---|---|---|---|
| ProgramID | smallint | IDENTITY | Yes | No |
| Address1 | varchar(50) | NULL | No | No |
| Address2 | varchar(50) | NULL | No | No |
| City | varchar(30) | NULL | No | No |
| State | char(2) | NULL | No | No |
| ZipCode | char(5) | NULL | No | No |
| ProgramType | varchar(50) | NULL | No | Yes |
| ProgramName | varchar(75) | NOT NULL | No | No |
| Disabled | bit | NOT NULL | No | No |

“ProgramTypes” Table

| | | | | |
|---|---|---|---|---|
| ProgramType | varchar(50) | NOT NULL | Yes | No |
| Notes | text | NULL | No | No |

“ReferralSources” Table

| | | | | |
|---|---|---|---|---|
| ReferralSourceID | smallint | IDENTITY | Yes | No |
| ReferralSource | varchar(30) | NOT NULL | No | No |

Column(s) of “Roles” Table “Roles” Table

| | | | | |
|---|---|---|---|---|
| Role | varchar(50) | NOT NULL | Yes | No |
| Notes | text | NULL | No | No |

“TestTypes” Table

| | | | | |
|---|---|---|---|---|
| TestType | varchar(50) | NOT NULL | Yes | No |
| Notes | text | NULL | No | No |

“WorkActivityTypes” Table

| | | | | |
|---|---|---|---|---|
| WorkActivityType | varchar(50) | NOT NULL | No | No |
| WorkActivityTypeID | smallint | IDENTITY | Yes | No |

At step 300 the individual case manager, after interviewing a particular client, enters goal-oriented information regarding progress elements (points for improvement) as well as social barriers faced by the client in accomplishing predefined social goals.

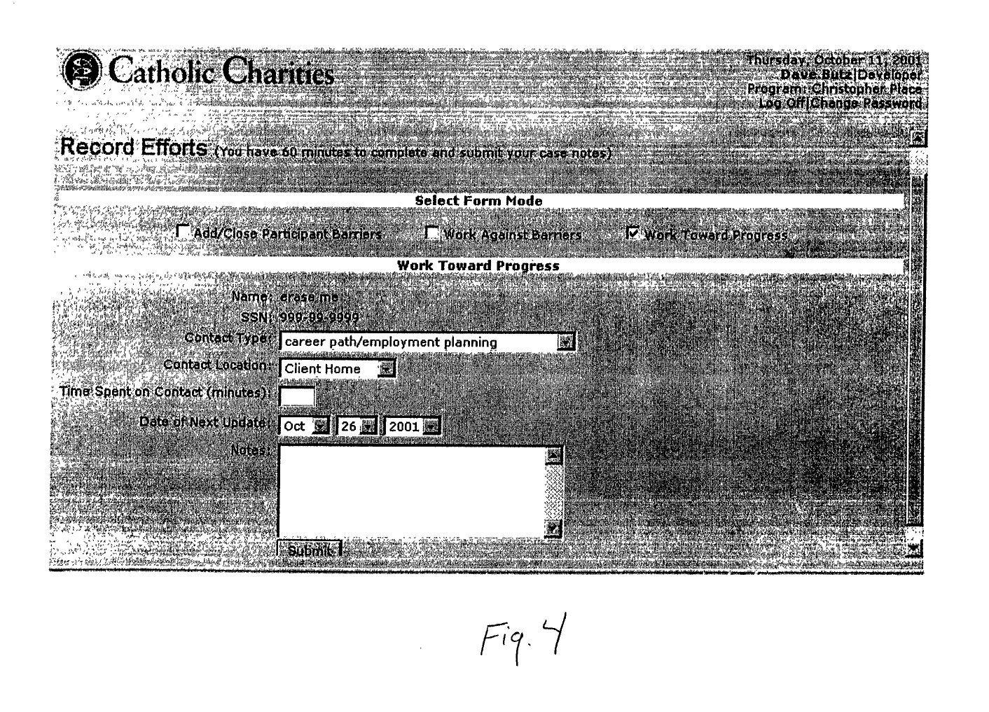

For goal-oriented progress elements, the caseworker enters status information to a predefined categorical list of Progress Elements. Again in the context of employment placement, exemplary Progress Elements may include Retention; New Employment; Wage Increase; Promotion; and Educational Advancement. In addition to measuring the client's progress, the caseworkers must also measure their own effort towards each progress element. This is important because it avoids vague “checkups” on clients when they have employment and helps the caseworkers focus their energies on aiding clients' progress towards specific goals. FIG. 4 is a screen print of an exemplary Progress Element entry screen by which the caseworker can specify a Progress Element (career path/employment planning), and enter contact information (location, time, date of next update and notes) regarding their own effort toward facilitating the specified Progress Element. By this approach, caseworker efforts can be measured against the outcomes produced. The periodic client contact data is used to populate relational database tables as shown below.

“ClientUpdateReasons” Table

| | | | | |
|---|---|---|---|---|
| Name | Datatype | Null Option | Is PK | Is FK |

“ClientUpdateReasons” Table

| | | | | |
|---|---|---|---|---|
| ReasonID | smallint | IDENTITY | Yes | No |
| Reason | varchar(100) | NULL | No | No |
| Notes | text | NULL | No | No |

“ClientUpdates” Table

| | | | | |
|---|---|---|---|---|
| ClientUpdateID | int | IDENTITY | Yes | No |
| PlacementID | smallint | NOT NULL | Yes | No |
| EmployeeID | smallint | NOT NULL | Yes | Yes |
| ClientUpdateReasonID | smallint | NULL | No | Yes |
| Notes | text | NULL | No | No |
| DateEntered | smalldatetime | NULL | No | No |

“ContactLocations” Table

| | | | | |
|---|---|---|---|---|
| ContactLocation | varchar(40) | NOT NULL | No | No |
| ContactLocationID | smallint | IDENTITY | Yes | No |
| Notes | text | NULL | No | No |

“ContactTypes” Table

| | | | | |
|---|---|---|---|---|
| ContactTypeID | int | IDENTITY | Yes | No |
| ContactType | varchar(50) | NOT NULL | No | No |

“DrugOfChoice” Table

| | | | | |
|---|---|---|---|---|
| DrugID | smallint | IDENTITY | Yes | No |
| DrugOfChoice | varchar(30) | NOT NULL | No | No |

“EmployeeMessage” Table

| | | | | |
|---|---|---|---|---|
| EmployeeID | smallint | NULL | No | Yes |
| EmployeeMessageID | int | IDENTITY | Yes | No |
| MessageID | smallint | NULL | No | Yes |
| ReadMessage | smallint | NULL | No | No |

“Employees” Table

| | | | | |
|---|---|---|---|---|
| EmployeeID | smallint | IDENTITY | Yes | No |
| ProgramID | smallint | NULL | No | Yes |
| FirstName | varchar(20) | NOT NULL | No | No |
| MiddleInitial | char(1) | NULL | No | No |
| LastName | varchar(40) | NOT NULL | No | No |
| EmployeeType | varchar(30) | NULL | No | Yes |
| Role | varchar(50) | NULL | No | Yes |
| Disabled | bit | NOT NULL | No | No |
| UserName | varchar(50) | NOT NULL | No | No |
| Password | varchar(50) | NOT NULL | No | No |

“EmployeeTypes” Table

| | | | | |
|---|---|---|---|---|
| EmployeeType | varchar(30) | NOT NULL | Yes | No |
| Notes | text | NULL | No | No |

“EmployerContactLocation” Table

| | | | | |
|---|---|---|---|---|
| EmployerContactLocation | varchar(40) | NOT NULL | No | No |
| Notes | text | NULL | No | No |
| EmployerContact- | smallint | IDENTITY | Yes | No |
| LocationID | | | | |

“EmployerContactType” Table

| | | | | |
|---|---|---|---|---|
| EmployerContactTypeID | int | IDENTITY | Yes | No |
| EmployerContactType | varchar(50) | NOT NULL | No | No |

“EmployerHistories” Table

| | | | | |
|---|---|---|---|---|
| EmployerID | smallint | NOT NULL | No | Yes |
| HistoryID | int | IDENTITY | Yes | No |
| DateEntered | datetime | NULL | No | No |
| EmployeeID | smallint | NULL | No | No |
| TimeSpentOnContact | int | NULL | No | No |
| ContactLocationID | smallint | NULL | No | Yes |
| ContactTypeID | int | NULL | No | Yes |
| NextExpectedUpdate | datetime | NOT NULL | No | No |
| Notes | text | NULL | No | No |

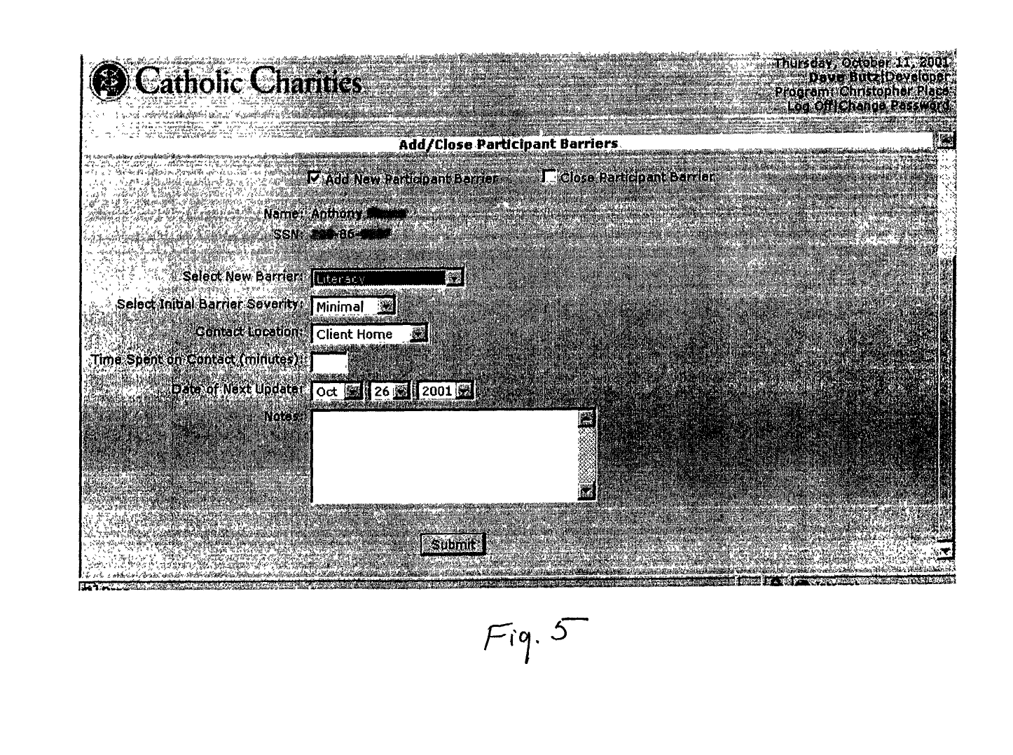

In addition to the Progress Element data, the data entry screen of FIG. 5 is used to specify Barriers to progress (such as Literacy), to specify Barrier Severity, and to enter contact information (location, time, date of next update and notes) regarding their own effort at each client contact toward reducing the specified Barrier severity or eliminating the Barrier completely. The periodic Barriers data is used to populate a relational database table as shown below.

“ClientHistories” Table

| Name | Datatype | Null Option | Is PK | Is FK |
|---|---|---|---|---|
| ClientHistoryID | smallint | IDENTITY | Yes | No |
| ClientBarrierID | smallint | NULL | No | Yes |
| DateRecorded | smalldatetime | NOT NULL | No | No |
| EmployeeID | smallint | NOT NULL | No | Yes |
| Note | text | NULL | No | No |
| BarrierSeverityID | smallint | NULL | No | Yes |
| TimeSpentOnContact | smallint | NOT NULL | No | No |
| DateNextUpdate | smalldatetime | NULL | No | No |
| SSN | varchar(11) | NOT NULL | No | Yes |
| ContactLocationID | smallint | NOT NULL | No | Yes |
| ContactTypeID | int | NULL | No | Yes |

In the context of employment placement, an exemplary set of predefined Barriers will include Day Care (whether the client requires day care for dependants); Transportation (whether the client requires transportation to/from work); Health Issues; Family Issues (e.g., divorce situation); Behavior (behavioral issues); Attitude; Weight; Personal Hygiene, Disability, Laziness; Money Management; Lack of Skills; and Literacy. Specific barriers may be defined and added to the knowledge base by the agency or caseworker, and are preferably supplemented by the individual case managers as they know best what stands in the way of their clients' success. The method also requires the subjective (but quantitative) identification of the severity of these barriers. Each barrier is assigned a BarrierID number, and the corresponding severity is identified by a SeverityID field which may be a scale of from 1 (lowest severity) to 10 (most severe). This assessment and definition of barriers allows them to be tracked, overcome and eventually closed by the caseworker. The barrier data is used to populate a relational database table a complete example of which is shown below.

“ClientBarriers” Table”

| Name | Datatype | Null Option | Is PK | Is FK |
|---|---|---|---|---|
| ClientBarrierID | smallint | IDENTITY | Yes | No |
| BarrierID | smallint | NOT NULL | No | Yes |
| SSN | varchar(11) | NOT NULL | No | Yes |
| BarrierIdentification Date | smalldatetime | NULL | No | No |
| BarrierClosed | bit | NULL | No | No |

The barrier severity data is used to populate a separate table as shown below.

“BarrierSeverities” Table

| Name | Datatype | Null Option | Is PK | Is FK |
|---|---|---|---|---|
| BarrierSevenityID | smallint | IDENTITY | Yes | No |
| BarrierSeverity | varchar(50) | NOT NULL | No | No |
| BarrierSeverity Value | smallint | NOT NULL | No | No |

In the software implementation, procedures are defined which enable the caseworker to define new client barriers, or to recall previously defined client barriers that already exist in the knowledgebase. An example procedure for adding a new barrier is as shown below, and predefined barriers are recalled based on the numeric BarrierID field.

| | |
|---|---|
| spAddClientBarriers | CREATE PROCEDURE [spAddClientBarriers] |

(
@BarrierID [smallint],
@SSN [varchar](11),
@EmpID smallint,
@SeverityID smallint,
@ContactLoc smallint,
@Time smallint,
@Update smalldatetime,
@Note text)

AS
Declare @NewCBID smallint
INSERT INTO [ClientBarriers]

([BarrierID],
[SSN])

VALUES

(@BarrierID,
@SSN)

set @NewCBID = @@Identity
Insert Into ClientHistories

(ClientBarrierID,
SSN,
EmployeeID,
BarrierSeverityID,
ContactLocationID,
TimeSpentOnContact,
DateNextUpdate,
Note)

Values

(@NewCBID,
@SSN,
@EmpID,
@SeverityID,
@ContactLoc,
@Time,
@Update,
@Note)

Once the caseworker, client, and client contact data (including progress elements and barriers) is entered as per steps 100-300, at step 400 the caseworker continues periodic client contact and at each point of contact reassesses the client.

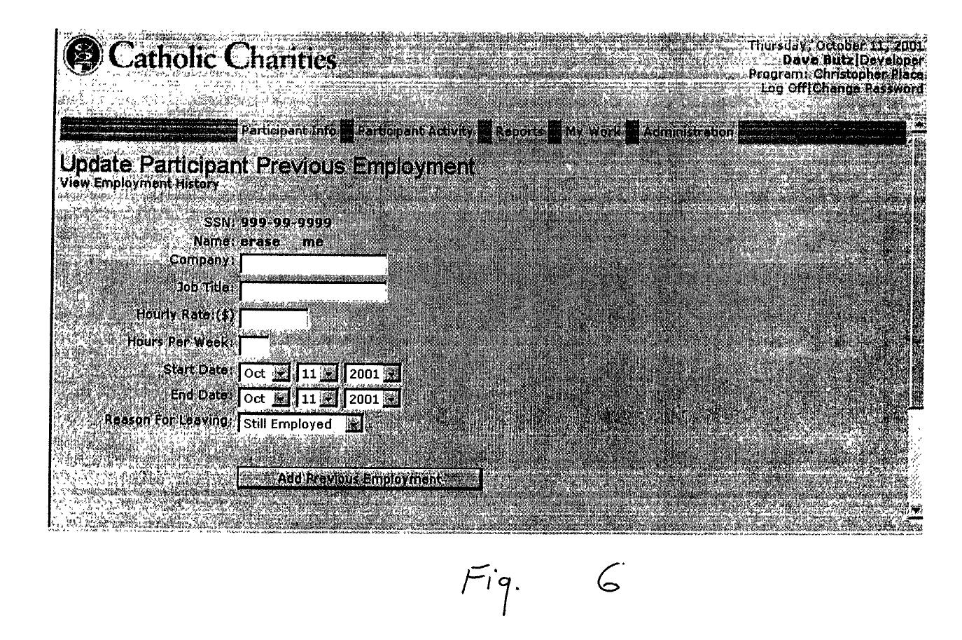

At this point, a succession of information update screens are provided to enable the caseworker to update client information which may have changed since the last contact. For example, FIG. 6 is a screen print of an “Update Previous Employment” screen by which the caseworker can update the client's employment history to reflect a change of employment. Additionally, the caseworker can return to the Progress entry screen of FIG. 4 and provide a progress update based on a new client contact, and/or return to the Barrier entry screen of FIG. 5 to update progress or even close out a Barrier to progress which has been overcome.

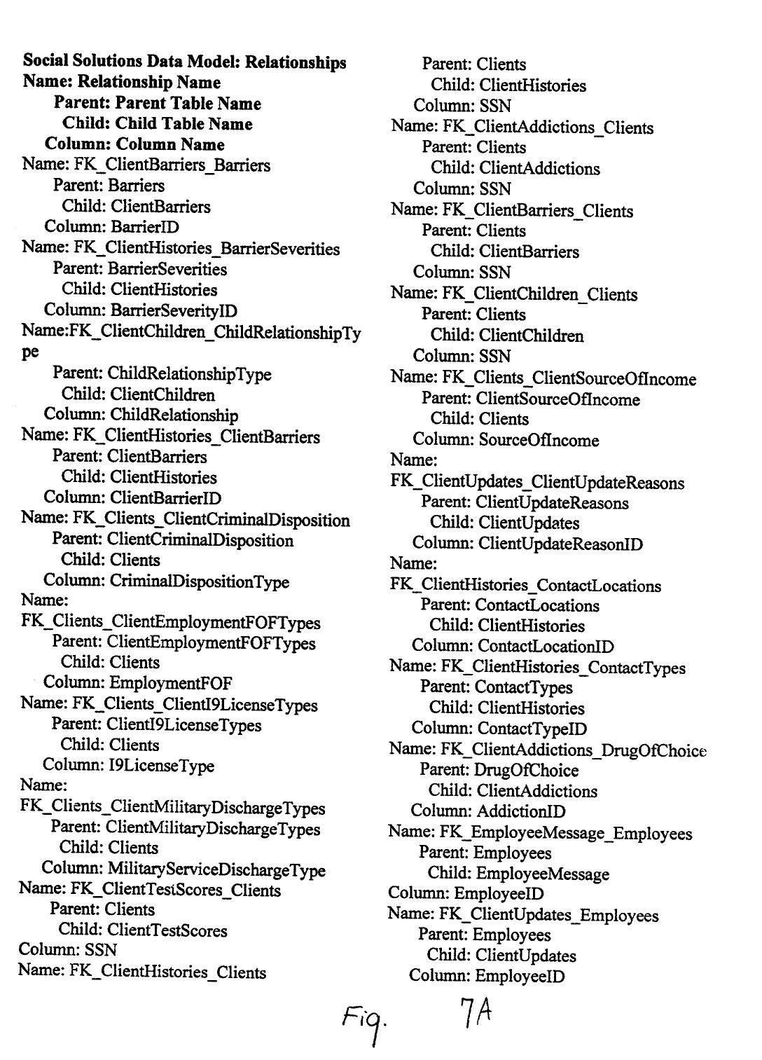

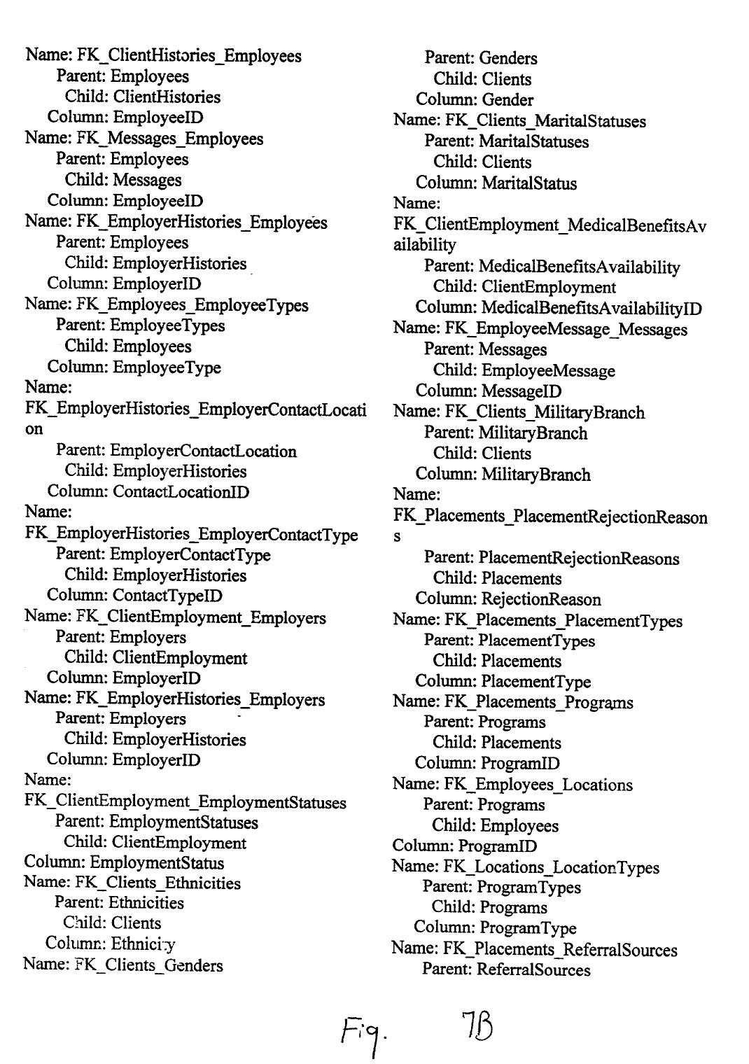

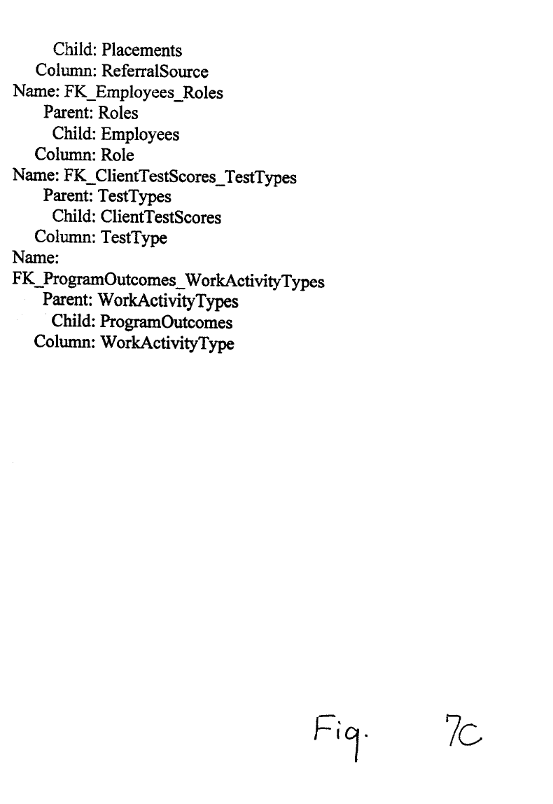

All of the foregoing tables are relationally-linked. FIGS. 7A-7C are a tabular listing of the preferred relational links between fields in the above described knowledgebase tables. A Relationship Name is given to each link, and the parent-child hierarchy is designated by the Parent Table Name and Child Table Name. The Column designation indicates the field-to-field assignments between common fields in related tables. All table data is stored in memory pursuant to the above-described storage structure in relational database format and thereby supports meaningful queries. Specifically, the method and data structure allows measurement of the efforts of caseworkers over time. In particular, one objective benchmark is provided by querying the client, caseworker and barrier data to measures the severities of barriers as caseworkers work against them (with clients) over time. This way, it is possible to assess how effective caseworkers are in reducing barriers over time. Another objective benchmark is provided by querying the client, caseworker and contact data to measure caseworker effects in specific contact types over time. These contact types are mapped to outcome indicators (like promotions) and it becomes possible to assess how effective caseworker are when their contact types (efforts) lead to desired outcomes.

Given a fully populated database as per steps 100-400, the caseworker and/or agency may initiate a reporting module as shown at step 500 which provides access to a predefined series of queries. The results of each query are displayed in a format conducive to the recipient of the information.

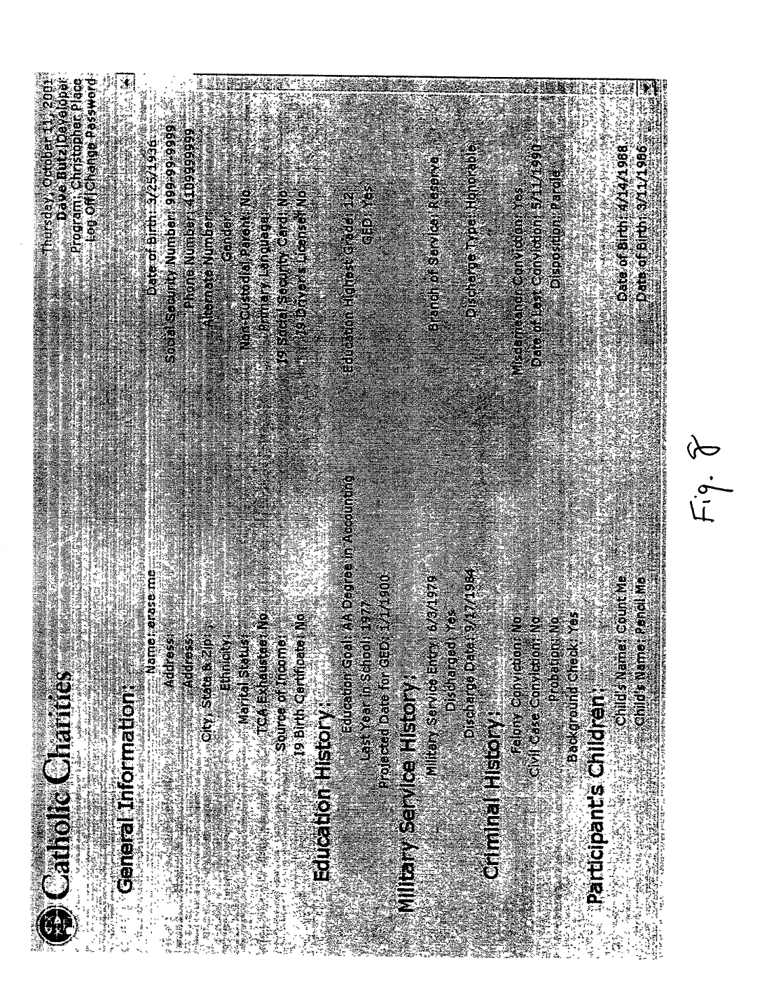

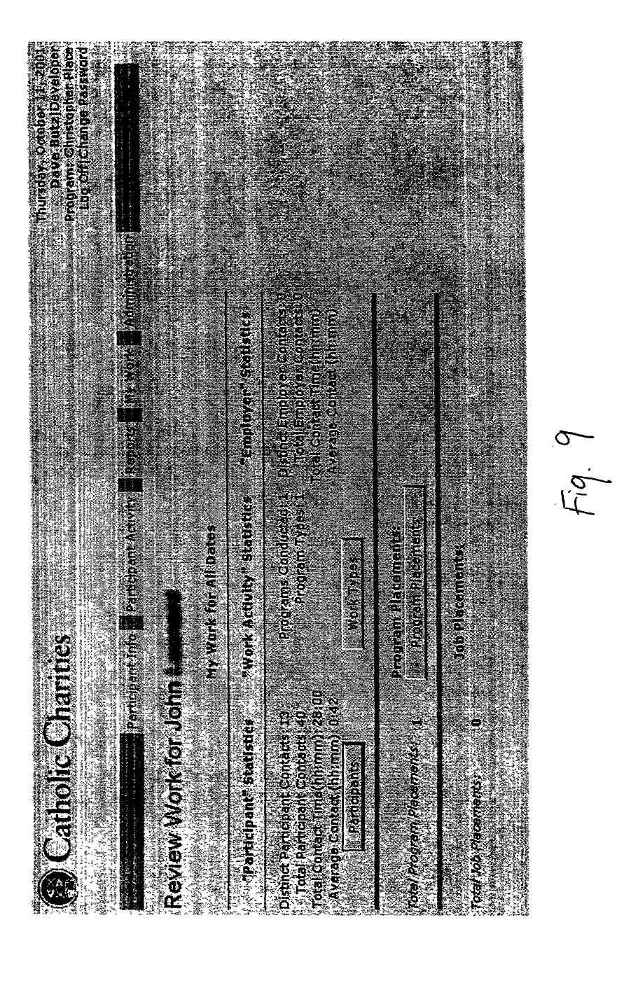

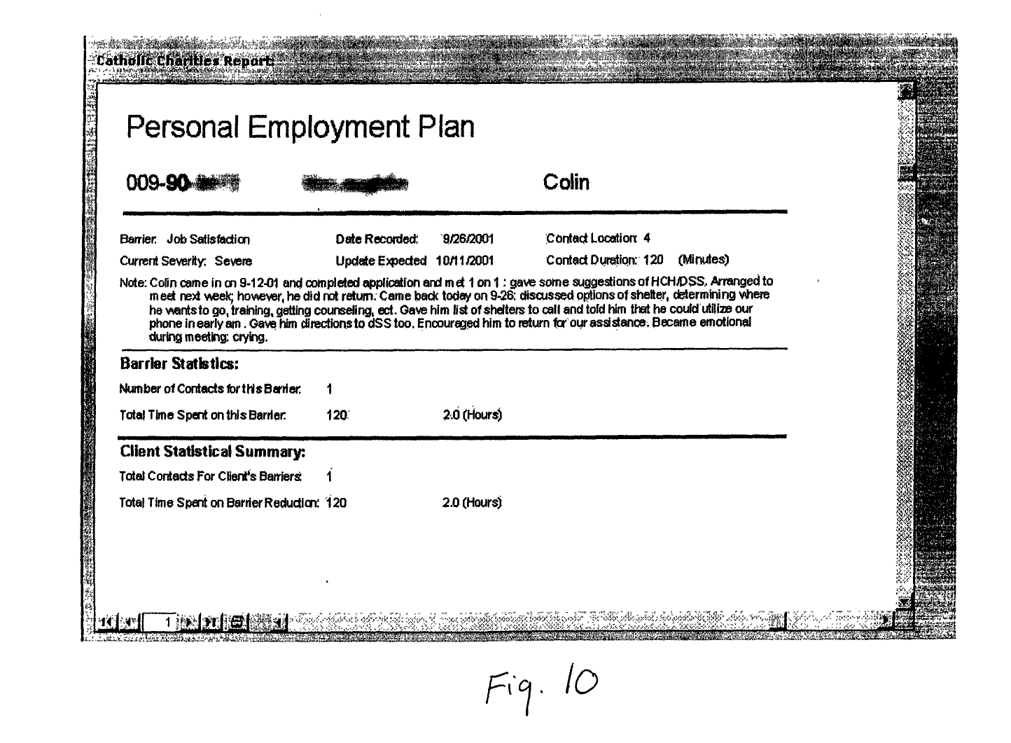

A series of “Other Reports” can be generated for simple information. For example, a Basic Client Information Report can be generated as shown in FIG. 8 to profile a given client. Alternatively, the agency can generate a caseworker report as shown in FIG. 9 to compile total client contact information for a given caseworker (“John”). Client-specific reports can be generated such as that shown in FIG. 10, which is the result of a query of client and barrier data presented as the statistics for reducing a given Barrier (here job satisfaction). Further, job placement reports, client employment history reports, and other client-oriented reports can readily be generated by the appropriate queries.

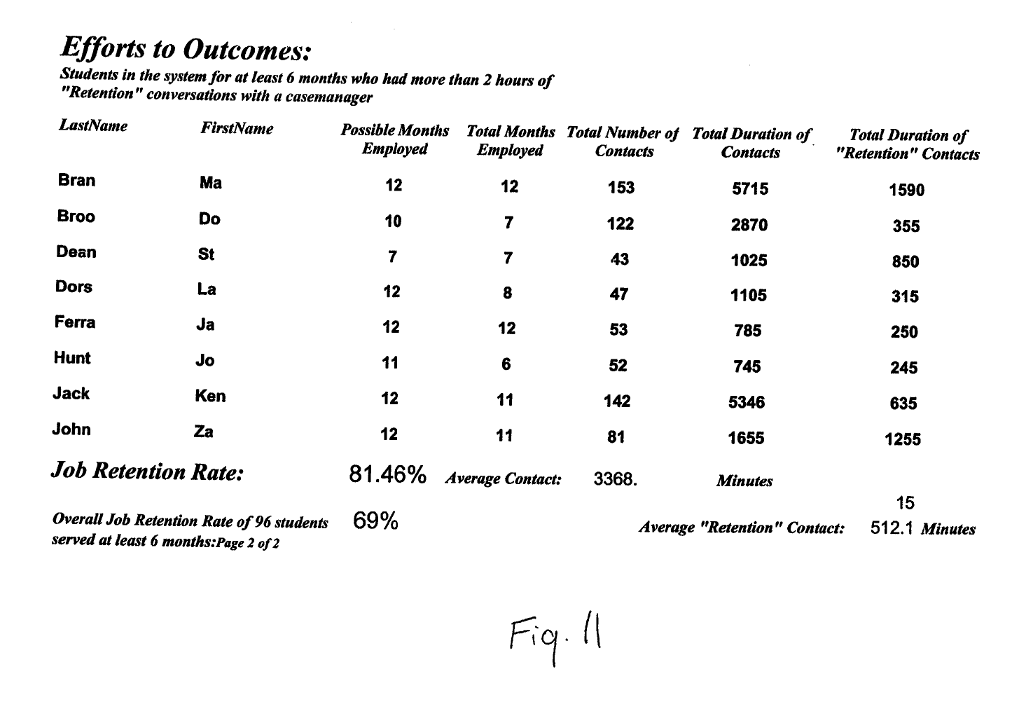

More importantly, the Progress Element and/or Barrier data can be effectively queried and presented for the benefit of the caseworker and/or caseworker-assessment by the agency. For example, as shown at step 600 (FIG. 1) the caseworker may seek a client-centric “Efforts to Outcomes” report which details clients in the system for at least 6 months who had more than 2 hours of“Retention” conversations with a casemanager. FIG. 11 is an example “Efforts to Outcomes” report which details (for each client) Possible Months Employed, Total Months Employed, Total Number of Contacts, Total Duration of Contacts, and Total Duration of “Retention” Contacts. Summary information is tabulated, and this includes average Job Retention Rate (81.46%), Average Contact (3368 Minutes), Overall Job Retention Rate of all students (69%), and Average “Retention” Contact (512.1 Minutes).

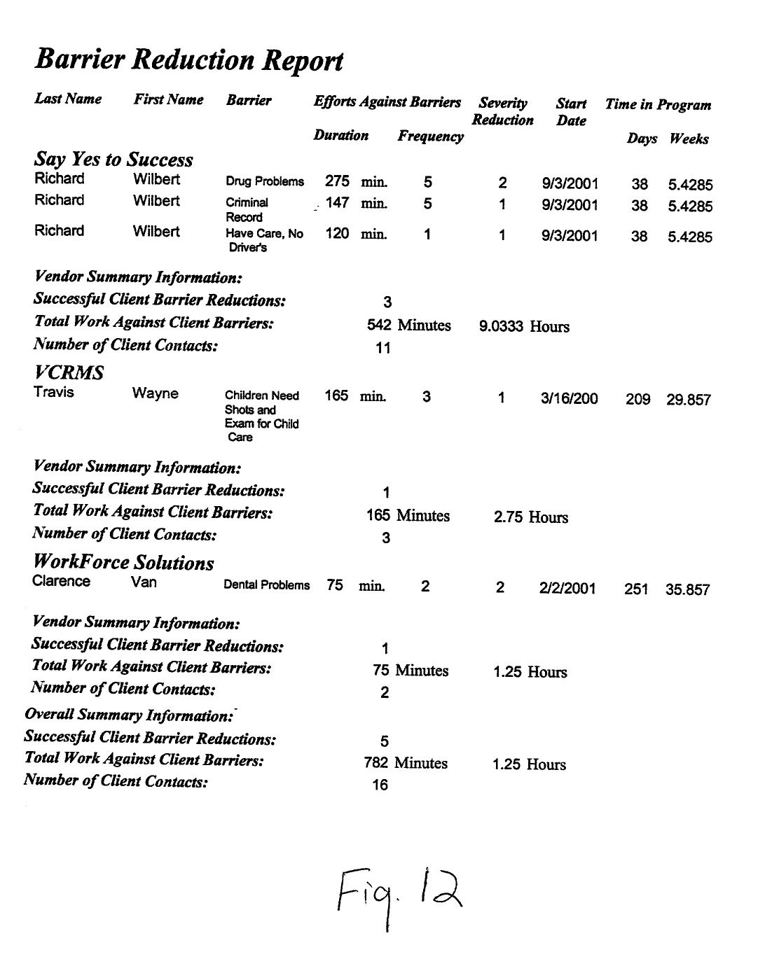

Alternatively, as shown at step 700 (FIG. 1) the agency may seek a caseworker-centric “Barrier Reduction Report” which details caseworker success with clients to help them overcome the barriers they face. FIG. 12 is an example “Barrier Reduction Report” report which details (for one or more caseworkers) each Barrier faced, the caseworker's Efforts Against Barriers, Severity of the Barrier, Start Date, and Time in Program (both days and weeks). The foregoing data is tabulated and a summary listing is provided which includes Successful Client Barrier Reductions (1), Total Work Against Client Barriers (75 Minutes, 1.25 Hours), Number of Client Contacts (2), Successful Client Barrier Reductions (5), Total Work Against Client Barriers (782 Minutes), and the total Number of Client Contacts (16). This form of report ensures that the agency can provide caseworkers (or caseworkers can provide the agency) with quantitative accountability for social services based on objective reduction of barriers.

The above-described method is implemented as software, and preferably “network software” designed to operate in the context of a local-area or distributed network that affords a multiple-user environment. The software is best configured as a true client-server application. This makes the software scalable in response to network expansion as well as capable of providing client data to different client-side applications without server-side reconfiguration. The server software runs on Microsoft SQL Server, including SQL 2000. The client software runs under Microsoft Windows 98, Windows NT, Windows 2000, XP or the like. The software can be installed on any network hardware that is supported by Microsoft Windows 98/NT/2000/XP, including Ethernet or token-ring hardware using NetBEUI, IPX, or TCP/IP protocols. For example, the method may be implemented over a 10-megabit Ethernet network using a 266-MHz single-processor Pentium server with at least 64 megabytes of RAM, and modest client-side machines (for example, a 100-MHz Pentium with at least 16 megabytes of RAM. The user interface is preferably a conventional color monitor, a dial-up or network connection, and a standard input device such as a mouse and keyboard. All data entry forms may be maintained on a designated internet server for user access. In any of the foregoing operating systems, the software may be incorporated as a program shell around existing relational database software such as, for instance, Microsoft Access (graphical database access), thereby providing built-in interoperability with peripheral programs such as Microsoft Word (word processor), Microsoft Excel (spreadsheet), and Microsoft Exchange (email server), etc. In operation, the present software provides a user interface that is simple and uncluttered. Typical user-interface response time is 0.5 seconds or less. Typical database response time (for data transfers between a client computer and the database server) is 2-3 seconds. Of course, performance will depend on the speed of the computer hardware and network.

The system described above (inclusive of hardware and software) provides for the tracking and assessment of social services based on a defined list of client barriers to success, and objective tracking of progress of the social worker based on the reduction and/or elimination of those barriers. The resultant information helps manage and coordinate resources for the achievement of optimal clinical and financial patient outcomes, and to facilitate collaborative patient care management across the continuum of available social services.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A method for the storage and querying of social services data in a knowledge base that provides quantitative accountability for social services via a navigable user interface, comprising the steps of:
collecting information relating to defined social services and providers;
collecting information relating to defined customers;
collecting information relating to defined client barriers to productivity;
collecting information relating to define customer outcomes;
incorporating said collected information into a structured relational database;
providing a graphical user interface with a plurality of single-click buttons each for initiating a pre-determined query for allowing a user to generate a report indicating reduction of said client barriers over time, thereby maintaining quantitative accountability for social services.

2. A method for the storage and querying of social services data in a knowledge base that provides quantitative accountability for social services via a navigable user interface, comprising the steps of:
collecting information relating to define social services and providers;
collecting information relating to defined customers;
collecting information relating to defined customer outcomes;
incorporating said collected information into a structured relational database;
providing a graphical user interface with a plurality of single-click buttons each for initiating a pre-determined query for allowing a user to generate a report for maintaining quantitative accountability for social services.

3. A method for providing quantitative accountability for social services, comprising the steps of:
defining categorical barriers to client productivity and indicating for each client and barrier a severity of said barrier;
counseling clients to overcome each of said barriers that they face;
assessing progress in reducing said severity or eliminating said client barriers over time.
